(19) United States
(12) Patent Application Publication
(10) Pub. No.: US 2024/0211779 A1
(43) Pub. Date: Jun. 27, 2024

(54) MACHINE LEARNING TECHNIQUES FOR MAINTAINING OPTIMUM NUMBER OF RESOURCES FOR DISTRUBUTION TO SELECTED ENTITIES BASED ON NON-CAUSAL INFERENCE

(71) Applicant: Optum Services (Ireland) Limited, Dublin (IE)

(72) Inventors: Breanndán O Conchuir, Warrington (GB); Conor John Waldron, Dublin (IE); Michael J. McCarthy, Dublin (IE); Kevin A. Heath, Dubin (IE)

(21) Appl. No.: 18/086,751

(22) Filed: Dec. 22, 2022

(51) Int. Cl. G06N 5/04; G06F 9/50; G06N 20/00

(52) U.S. Cl. CPC G06N 5/04; G06F 9/5027; G06N 20/00

(57) ABSTRACT

Various embodiments of the present disclosure provide methods, apparatus, systems, computing devices, computing entities, and/or the like for improving allocation of limited resources by determining an optimal amount of resources to allocate to resource-receiving entities in each of one or more resource-receiving entity cohorts based on non-linear causal effect predictions, and determining an optimum operation configuration based on the determined optimal amount of resource. Non-linear causal effect of selected amounts of resources assigned to specific resource-receiving entities are predicted on an outcome of interest associated with the resource-receiving entities.

### BACKGROUND

Various embodiments of the present disclosure address technical challenges related to managing computing systems with finite resources and prioritizing resource-receiving entities for allocating resources most effectively.

### BRIEF SUMMARY

In general, various embodiments of the present disclosure provide methods, apparatus, systems, computing devices, computing entities, and/or the like for identifying an optimal amount of resources to assign to resource-receiving entity cohorts to maximize benefit from the allocation of resources.

In accordance with one aspect, a method is provided. In one embodiment, the method comprises: receiving, via one or more processors, historical data and directed acyclic graph data, wherein: (i) the historical data comprises one or more outcomes associated with one or more resource-receiving entities, (ii) each of the one or more outcomes comprising a causal variable value and a pre-defined time window, and (iii) the directed acyclic graph data comprises expert knowledge data; generating, via the one or more processors and using a resource allocation machine learning framework, one or more non-linear causal effect predictions of one or more causal variables on an outcome of interest associated with the one or more resource-receiving entities based on the historical data and the directed acyclic graph data, wherein: (a) the resource allocation machine learning framework comprises a non-linear causal inference machine learning model, (b) the non-linear causal inference machine learning model is configured to: (i) determine, for each causal variable value selected from a plurality of causal variable values, an outcome value for one or more resource-receiving entities based on the historical data, and (ii) determine an optimal causal variable value for each of one or more resource-receiving entity cohorts by applying supervised machine learning regression to a plurality of outcome values associated with one or more resource-receiving entities of a respective resource-receiving entity cohort based on the directed acyclic graph; determining, via the one or more processors, an optimum operation configuration based on one or more optimal causal variable values associated with the one or more non-linear causal effect predictions; and initiating, via the one or more processors, performance of one or more prediction-based actions based on the optimum operation configuration.

In accordance with another aspect, an apparatus comprising at least one processor and at least one memory including computer program code is provided. In one embodiment, the at least one memory and the computer program code may be configured to, with the processor, cause the apparatus to: receive historical data and directed acyclic graph data, wherein: (i) the historical data comprises one or more outcomes associated with one or more resource-receiving entities, (ii) each of the one or more outcomes comprising a causal variable value and a pre-defined time window, and (iii) the directed acyclic graph data comprises expert knowledge data; generate, using a resource allocation machine learning framework, one or more non-linear causal effect predictions of one or more causal variables on an outcome of interest associated with the one or more resource-receiving entities based on the historical data and the directed acyclic graph data, wherein: (a) the resource allocation machine learning framework comprises a non-linear causal inference machine learning model, (b) the non-linear causal inference machine learning model is configured to: (i) determine, for each causal variable value selected from a plurality of causal variable values, an outcome value for one or more resource-receiving entities based on the historical data, and (ii) determine an optimal causal variable value for each of one or more resource-receiving entity cohorts by applying supervised machine learning regression to a plurality of outcome values associated with one or more resource-receiving entities of a respective resource-receiving entity cohort based on the directed acyclic graph; determine an optimum operation configuration based on one or more optimal causal variable values associated with the one or more non-linear causal effect predictions; and initiate performance of one or more prediction-based actions based on the optimum operation configuration.

In accordance with yet another aspect, a computer program product is provided. The computer program product may comprise at least one computer-readable storage medium having computer-readable program code portions stored therein, the computer-readable program code portions comprising executable portions configured to: receive historical data and directed acyclic graph data, wherein: (i) the historical data comprises one or more outcomes associated with one or more resource-receiving entities, (ii) each of the one or more outcomes comprising a causal variable value and a pre-defined time window, and (iii) the directed acyclic graph data comprises expert knowledge data; generate, using a resource allocation machine learning framework, one or more non-linear causal effect predictions of one or more causal variables on an outcome of interest associated with the one or more resource-receiving entities based on the historical data and the directed acyclic graph data, wherein: (a) the resource allocation machine learning framework comprises a non-linear causal inference machine learning model, (b) the non-linear causal inference machine learning model is configured to: (i) determine, for each causal variable value selected from a plurality of causal variable values, an outcome value for one or more resource-receiving entities based on the historical data, and (ii) determine an optimal causal variable value for each of one or more resource-receiving entity cohorts by applying supervised machine learning regression to a plurality of outcome values associated with one or more resource-receiving entities of a respective resource-receiving entity cohort based on the directed acyclic graph; determine an optimum operation configuration based on one or more optimal causal variable values associated with the one or more non-linear causal effect predictions; and initiate performance of one or more prediction-based actions based on the optimum operation configuration.

### BRIEF DESCRIPTION OF THE DRAWINGS

Having thus described the disclosure in general terms, reference will now be made to the accompanying drawings, which are not necessarily drawn to scale, and wherein:

FIG. 1 provides an example overview of an architecture that can be used to practice embodiments of the present disclosure.

FIG. 2 provides an example predictive data analysis computing entity in accordance with some embodiments discussed herein.

FIG. 3 provides an example client computing entity in accordance with some embodiments discussed herein.

FIG. 4 is a flowchart diagram of an example process for determining optimal resource allocation quantity or frequency to resource-requesting entities in accordance with some embodiments discussed herein.

FIG. 5 is a flowchart diagram of an example process for determining optimal causal variable values in accordance with some embodiments discussed herein.

FIG. 6A and FIG. 6B illustrate operational examples of directed acyclic graphs in accordance with some embodiments discussed herein.

FIG. 7A and FIG. 7B illustrate operational examples of non-linear causal effect in accordance with some embodiments discussed herein.

FIG. 8A and FIG. 8B illustrate operational examples of different causal benefit curves for respective resource-receiving entity cohorts in accordance with some embodiments discussed herein.

### DETAILED DESCRIPTION

Various embodiments of the present disclosure are described more fully hereinafter with reference to the accompanying drawings, in which some, but not all embodiments of the present disclosure are shown. Indeed, the present disclosure may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “example” are used to be examples with no indication of quality level. Terms such as “computing,” “determining,” “generating,” and/or similar words are used herein interchangeably to refer to the creation, modification, or identification of data. Further, “based on,” “based at least in part on,” “based at least on,” “based upon,” and/or similar words are used herein interchangeably in an open-ended manner such that they do not indicate being based only on or based solely on the referenced element or elements unless so indicated. Like numbers refer to like elements throughout.

### I. Computer Program Products, Methods, and Computing Entities

Embodiments of the present disclosure may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may also be implemented as methods, apparatus, systems, computing devices, computing entities, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that comprises combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flowchart illustrations. Accordingly, the block diagrams and flowchart illustrations support various combinations of embodiments for performing the specified instructions, operations, or steps.

### II. Example Framework

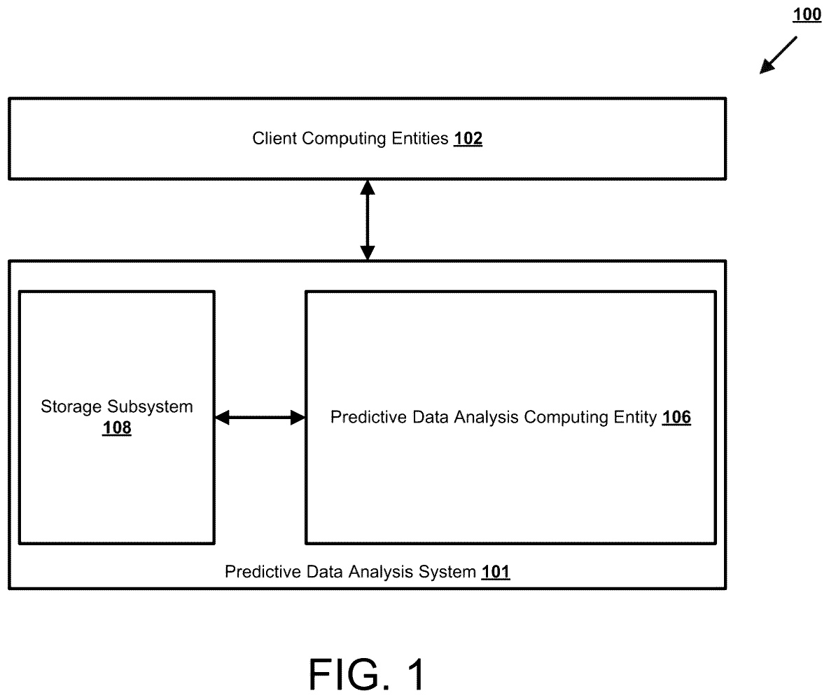

FIG. 1 is a schematic diagram of an example architecture 100 for performing predictive data analysis. The architecture 100 includes a predictive data analysis system 101 configured to receive predictive data analysis requests from client computing entities 102, process the predictive data analysis requests to generate predictions, provide the generated predictions to the client computing entities 102, and automatically initiate performance of prediction-based actions based on in part on the generated predictions.

An example of a prediction-based action that can be performed using the predictive data analysis system 101 comprises a response to receiving a request for allocating one or more resources. The response may comprise performing a resource-based action (e.g., allocation of resource), generating a diagnostic report, generating action scripts, generating alerts or messages, and generating one or more electronic communications based on an optimum operation configuration for each of the one or more resource-receiving entity cohorts. The optimum operation configuration may be determined based on an optimal causal variable value for each of the one or more resource-receiving entity cohorts, wherein the optimal causal variable value may be determined by applying supervised machine learning regression to a plurality of outcome values associated with one or more resource-receiving entities of a respective resource-receiving entity cohort based on the directed acyclic graph.

In accordance with various embodiments of the present disclosure, a resource allocation machine learning framework may be configured to determine resource-receiving entity cohorts benefiting most from one or more resource allocations based on a non-linear causal effect prediction. In particular, the resource allocation machine learning framework may comprise a non-linear causal inference machine learning model that is trained to predict non-linear causal effects of resource allocation to resource-receiving entities for an outcome of interest based on historical data and directed acyclic graph data. As such, one or more non-linear causal effect predictions of one or more causal variables (e.g., amount of resource allocation) on an outcome of interest may be performed based on historical data and directed acyclic graph data. This technique will lead to higher success of resource allocation operations as needed for certain resource-receiving entities. In doing so, the techniques described herein improve efficiency and quality-of-service. Accordingly, the techniques described herein improve at least one of the computational efficiency, storage-wise efficiency, and operational efficiency of computational systems.

In some embodiments, predictive data analysis system 101 may communicate with at least one of the client computing entities 102 using one or more communication networks. Examples of communication networks include any wired or wireless communication network including, for example, a wired or wireless local area network (LAN), personal area network (PAN), metropolitan area network (MAN), wide area network (WAN), or the like, as well as any hardware, software and/or firmware required to implement it (such as, e.g., network routers, and/or the like).

The predictive data analysis system 101 may include a predictive data analysis computing entity 106 and a storage subsystem 108. The predictive data analysis computing entity 106 may be configured to receive predictive data analysis requests from one or more client computing entities 102, process the predictive data analysis requests to generate predictions corresponding to the predictive data analysis requests, provide the generated predictions to the client computing entities 102, and automatically initiate performance of prediction-based actions based on in part on the generated predictions.

The storage subsystem 108 may be configured to store input data used by the predictive data analysis computing entity 106 to perform predictive data analysis as well as model definition data used by the predictive data analysis computing entity 106 to perform various predictive data analysis tasks. The storage subsystem 108 may include one or more storage units, such as multiple distributed storage units that are connected through a computer network. Each storage unit in the storage subsystem 108 may store at least one of one or more data assets and/or one or more data about the computed properties of one or more data assets. Moreover, each storage unit in the storage subsystem 108 may include one or more non-volatile storage or memory media including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

### A. Example Predictive Data Analysis Computing Entity

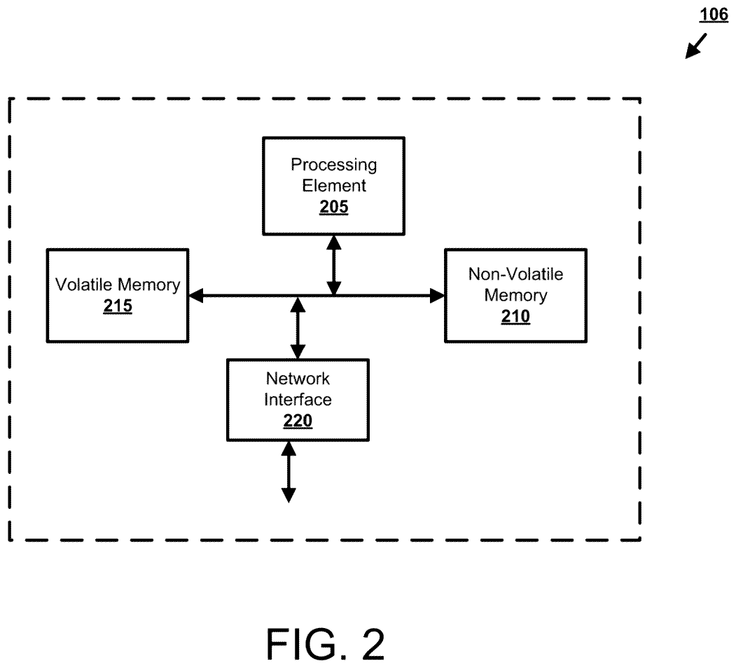

FIG. 2 provides a schematic of a predictive data analysis computing entity 106 according to one embodiment of the present disclosure. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably.

As indicated, in one embodiment, the predictive data analysis computing entity 106 may also include one or more network interfaces 220 for communicating with various computing entities, such as by communicating data, content, information, and/or similar terms used herein interchangeably that can be transmitted, received, operated on, processed, displayed, stored, and/or the like.

As shown in FIG. 2, in one embodiment, the predictive data analysis computing entity 106 may include, or be in communication with, one or more processing elements 205 (also referred to as processors, processing circuitry, and/or similar terms used herein interchangeably) that communicate with other elements within the predictive data analysis computing entity 106 via a bus, for example. As will be understood, the processing element 205 may be embodied in a number of different ways.

For example, the processing element 205 may be embodied as one or more complex programmable logic devices (CPLDs), microprocessors, multi-core processors, coprocessing entities, application-specific instruction-set processors (ASIPs), microcontrollers, and/or controllers. Further, the processing element 205 may be embodied as one or more other processing devices or circuitry. The term circuitry may refer to an entirely hardware embodiment or a combination of hardware and computer program products. Thus, the processing element 205 may be embodied as integrated circuits, application specific integrated circuits (ASICs), field programmable gate arrays (FPGAs), programmable logic arrays (PLAs), hardware accelerators, other circuitry, and/or the like.

As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present disclosure when configured accordingly.

In one embodiment, the predictive data analysis computing entity 106 may further include, or be in communication with, non-volatile media (also referred to as non-volatile storage, memory, memory storage, memory circuitry and/or similar terms used herein interchangeably). In one embodiment, the non-volatile storage or memory may include one or more non-volatile memory 210, including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

As will be recognized, the non-volatile storage or memory media may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or data that is stored in a computer-readable storage medium using one or more database models, such as a hierarchical database model, network model, relational model, entity-relationship model, object model, document model, semantic model, graph model, and/or the like.

In one embodiment, the predictive data analysis computing entity 106 may further include, or be in communication with, volatile media (also referred to as volatile storage, memory, memory storage, memory circuitry and/or similar terms used herein interchangeably). In one embodiment, the volatile storage or memory may also include one or more volatile memory 215, including, but not limited to, RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like.

As will be recognized, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, the processing element 205. Thus, the databases, database instances, database management systems, data, applications, programs, program modules, scripts, source code, object code, byte code, compiled code, interpreted code, machine code, executable instructions, and/or the like may be used to control certain aspects of the operation of the predictive data analysis computing entity 106 with the assistance of the processing element 205 and operating system.

As indicated, in one embodiment, the predictive data analysis computing entity 106 may also include one or more network interfaces 220 for communicating with various computing entities, such as by communicating data, content, information, and/or similar terms used herein interchangeably that can be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the predictive data analysis computing entity 106 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the predictive data analysis computing entity 106 may include, or be in communication with, one or more input elements, such as a keyboard input, a mouse input, a touch screen/display input, motion input, movement input, audio input, pointing device input, joystick input, keypad input, and/or the like. The predictive data analysis computing entity 106 may also include, or be in communication with, one or more output elements (not shown), such as audio output, video output, screen/display output, motion output, movement output, and/or the like.

### B. Example Client Computing Entity

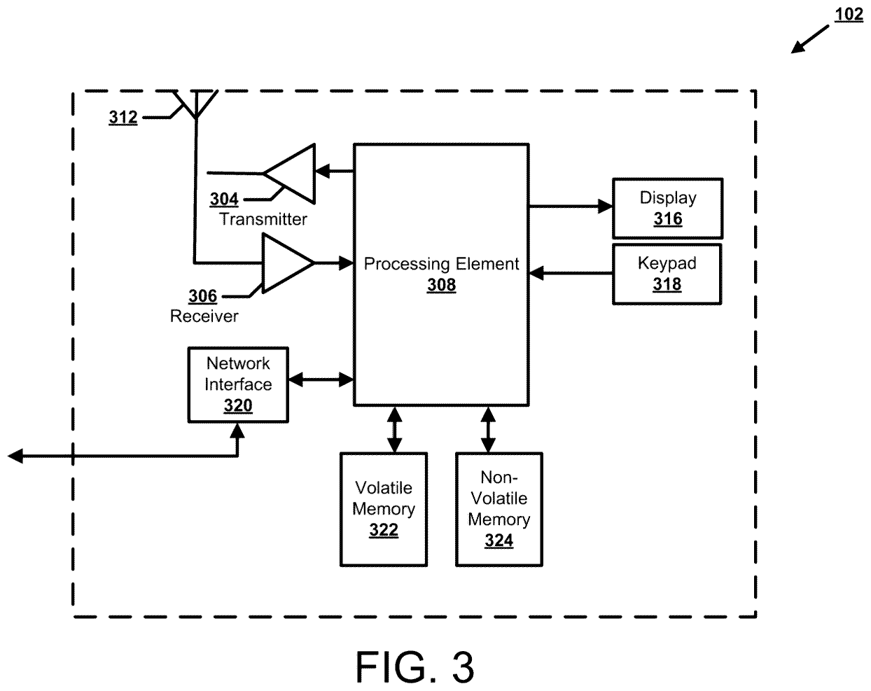

FIG. 3 provides an illustrative schematic representative of a client computing entity 102 that can be used in conjunction with embodiments of the present disclosure. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Client computing entities 102 can be operated by various parties. As shown in FIG. 3, the client computing entity 102 can include an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, correspondingly.

The signals provided to and received from the transmitter 304 and the receiver 306, correspondingly, may include signaling information/data in accordance with air interface standards of applicable wireless systems. In this regard, the client computing entity 102 may be capable of operating with one or more air interface standards, communication protocols, modulation types, and access types. More particularly, the client computing entity 102 may operate in accordance with any of a number of wireless communication standards and protocols, such as those described above with regard to the predictive data analysis computing entity 106. In a particular embodiment, the client computing entity 102 may operate in accordance with multiple wireless communication standards and protocols, such as UMTS, CDMA2000, 1×RTT, WCDMA, GSM, EDGE, TD-SCDMA, LTE, E-UTRAN, EVDO, HSPA, HSDPA, Wi-Fi, Wi-Fi Direct, WiMAX, UWB, IR, NFC, Bluetooth, USB, and/or the like. Similarly, the client computing entity 102 may operate in accordance with multiple wired communication standards and protocols, such as those described above with regard to the predictive data analysis computing entity 106 via a network interface 320.

Via these communication standards and protocols, the client computing entity 102 can communicate with various other entities using concepts such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The client computing entity 102 can also download changes, add-ons, and updates, for instance, to its firmware, software (e.g., including executable instructions, applications, program modules), and operating system.

According to some embodiments, the client computing entity 102 may include location determining aspects, devices, modules, functionalities, and/or similar words used herein interchangeably. For example, the client computing entity 102 may include outdoor positioning aspects, such as a location module adapted to acquire, for example, latitude, longitude, altitude, geocode, course, direction, heading, speed, universal time (UTC), date, and/or various other information/data. In one embodiment, the location module can acquire data, sometimes known as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data can be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data can be determined by triangulating the position of the client computing entity 102 in connection with a variety of other systems, including cellular towers, Wi-Fi access points, and/or the like. Similarly, the client computing entity 102 may include indoor positioning aspects, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops) and/or the like. For instance, such technologies may include the iBeacons, Gimbal proximity beacons, Bluetooth Low Energy (BLE) transmitters, NFC transmitters, and/or the like. These indoor positioning aspects can be used in a variety of settings to determine the location of someone or something to within inches or centimeters.

The client computing entity 102 may also comprise a user interface (that can include a display 316 coupled to a processing element 308) and/or a user input interface (coupled to a processing element 308). For example, the user interface may be a user application, browser, user interface, and/or similar words used herein interchangeably executing on and/or accessible via the client computing entity 102 to interact with and/or cause display of information/data from the predictive data analysis computing entity 106, as described herein. The user input interface can comprise any of a number of devices or interfaces allowing the client computing entity 102 to receive data, such as a keypad 318 (hard or soft), a touch display, voice/speech or motion interfaces, or other input device. In embodiments including a keypad 318, the keypad 318 can include (or cause display of) the conventional numeric (0-9) and related keys (#, *), and other keys used for operating the client computing entity 102 and may include a full set of alphabetic keys or set of keys that may be activated to provide a full set of alphanumeric keys. In addition to providing input, the user input interface can be used, for example, to activate or deactivate certain functions, such as screen savers and/or sleep modes.

The client computing entity 102 can also include volatile memory 322 and/or non-volatile memory 324, which can be embedded and/or may be removable. For example, the non-volatile memory 324 may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. The volatile memory 322 may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile and non-volatile memory can store databases, database instances, database management systems, data, applications, programs, program modules, scripts, source code, object code, byte code, compiled code, interpreted code, machine code, executable instructions, and/or the like to implement the functions of the client computing entity 102. As indicated, this may include a user application that is resident on the entity or accessible through a browser or other user interface for communicating with the predictive data analysis computing entity 106 and/or various other computing entities.

In another embodiment, the client computing entity 102 may include one or more components or functionality that are the same or similar to those of the predictive data analysis computing entity 106, as described in greater detail above. As will be recognized, these architectures and descriptions are provided for example purposes only and are not limiting to the various embodiments.

In various embodiments, the client computing entity 102 may be embodied as an artificial intelligence (AI) computing entity, such as an Amazon Echo, Amazon Echo Dot, Amazon Show, Google Home, and/or the like. Accordingly, the client computing entity 102 may be configured to provide and/or receive information/data from a user via an input/output mechanism, such as a display, a camera, a speaker, a voice-activated input, and/or the like. In certain embodiments, an AI computing entity may comprise one or more predefined and executable program algorithms stored within an onboard memory storage module, and/or accessible over a network. In various embodiments, the AI computing entity may be configured to retrieve and/or execute one or more of the predefined program algorithms upon the occurrence of a predefined trigger event.

### III. Examples of Certain Terms

The term “resource-receiving entity” may refer to a data construct that describes an object, article, file, program, service, task, operation, computing, and/or the like unit that receives resources or actions as a resource (generally referred to herewith as allocation of resource(s)), to execute an operation, perform a task, maintain or advance a state, or continue functioning. A resource-receiving entity may be allocated resources either upon a given condition, as determined by a policy, or periodically. For example, a computing device may determine whether to allocate a resource to a resource-receiving entity.

The term “resource” may refer to a data construct that describes a physical or virtual component of limited availability, such as within or may be provided by a computer system. For example, connected devices and system components may be accessed as resources. Virtual resources may include files, network connections, and memory areas. Additional examples of resources may comprise computation time, a number of steps necessary to solve a problem, processes, tasks, services, and memory space, such as an amount of storage needed while solving the problem. In some embodiments, a resource may also be associated with a stock or supply of money, materials, staff, support, and other assets that can be drawn on by a computing system.

The term “historical data” may refer to a data construct that describes a recording of structured and/or unstructured data associated with actions, such as resource allocations, with respect to one or more resource-receiving entities and outcomes as a result of the actions. In one embodiment, historical data may comprise data records associated with one or more outcomes of interest for one or more resource-receiving entities. A data record may comprise one or more causal variables, respective causal variable values of the one or more causal variables, actions, one or more outcome values associated with the one or more causal variables with the respective causal variable values and the actions, and a pre-defined time window. As an example, historical data may comprise a log of activity, events, diagnosis, statistics, actions or procedures, and any other information associated with the one or more resource-receiving entities. The historical data may be stored in a database and provided as input to a resource allocation machine learning framework for generating a non-linear causal effect prediction output.

The term “causal variable” may refer to a data construct that describes an independent variable associated with an action that produces a causal effect that may be either linear or non-linear. In one embodiment, a causal variable may comprise an action that produces a causal effect. For example, a causal variable may comprise a data variable associated with quantity of actions (e.g., resource allocations) enacted on a resource-receiving entity. According to various embodiments of the present disclosure, a causal effect on an outcome associated with a resource-receiving entity may be attributed to a causal variable. That is, a causal variable, such as quantity of actions, may effect a linear or non-linear change in an outcome associated with a resource-receiving entity.

The term “causal variable value” may refer to a data construct that describes a value of a causal variable. For example, a causal variable may represent quantity of actions (e.g., resource allocations) and a causal variable value for the causal variable may comprise a numerical value corresponding to the quantity of actions. According to another example, a causal variable may represent a data field and a causal variable value for the causal variable may comprise a binary, decimal, or hexadecimal value representative of an existence of an attribute and/or a descriptor of the data field.

The term “resource allocation machine learning framework” may refer to a data construct that describes parameters, hyperparameters, and/or defined operations of a machine learning model that is configured to generate one or more non-linear causal effect predictions of one or more causal variables on an outcome of interest associated with a resource-receiving entity based on historical data and directed acyclic graph data. According to various embodiments of the present disclosure, the resource allocation machine learning framework may comprise a non-linear causal inference machine learning model, such as a non-parametric double/debiased machine learning model.

The term “directed acyclic graph data” may refer to a data construct that describes expert knowledge data comprising one or more relationships between various causal variables, actions (e.g., resource allocation), and outcomes. Directed acyclic graph data may comprise a directed acyclic graph data object that is representative of a causal diagram including assumptions, for example, variables to control for (e.g., accounting for extraneous or non-causal variables), and relationships (e.g., directed) between different causal variables (e.g., independent variables), confounders, and outcomes (e.g., dependent variables). In some embodiments, directed acyclic graph data may be stored on one or more databases and retrieved as input to a causal inference machine learning model to impart expert knowledge about relationships between different data points. As an example, directed acyclic graph data may include directionality of how variable ‘X’ causes variable ‘Y’ (and not vice versa), of how variable ‘Z’ depends on variable ‘X’ but not on variable ‘Y,’ of how variable ‘W’ causes variables ‘Z’ and ‘Y’ but not variable ‘X.’

The term “non-linear causal effect prediction” may refer to a data construct that describes a prediction on an effect on an outcome (e.g., an outcome of interest associated with a resource-receiving entity) due to one or more causal variables based on historical data and directed acyclic graph data. In some embodiments, a non-linear causal effect prediction may comprise an optimal causal variable value determined for each of one or more resource-receiving entity cohorts by a non-linear causal inference machine learning model.

The term “non-linear causal inference machine learning model” may refer to a data construct that describes parameters, hyperparameters, and/or defined operations of a machine learning model that is configured to: (i) determine, for each causal variable value selected from a plurality of causal variable values, an outcome value for one or more resource-receiving entities based on the historical data, and (ii) determine an optimal causal variable value for each of one or more resource-receiving entity cohorts by applying supervised machine learning regression to a plurality of outcome values associated with one or more resource-receiving entities of a respective resource-receiving entity cohort based on the directed acyclic graph. One or more optimal causal variable values may be used to determine an optimum operation configuration. In one embodiment, the non-linear causal inference machine learning model may comprise a non-parametric double/debiased machine learning model.

The term “outcome value” may refer to a data construct that describes a quantitative value representative of a causal effect of a causal variable value selected for a causal variable on an outcome of interest associated with a resource-receiving entity.

The term “outcome of interest” may refer to a data construct that describes a dependent variable that may be varied based on causal variable values selected for one or more causal variables. Generally, an outcome of interest may represent a desired state or condition of a resource-receiving entity.

The term “supervised machine learning regression” may refer to analysis performed by a machine learning model, such as a non-linear causal inference machine learning model, to model a relationship between one or more independent variables (e.g., causal variables) and a dependent variable (e.g., outcome of interest). For example, supervised machine learning regression may comprise identifying or determining an effect of causal variables (e.g., allocation of resources) on an outcome of interest for members of a selected resource-receiving entity cohort over a period of time. In one embodiment, supervised machine learning regression may comprise a prediction of a continuous value that forecasts a trend by generating a causal benefit curve associated with a plurality of outcome values and a plurality of causal variable values. The generated causal benefit curve may comprise a best-fit curve between data values of a plot between the plurality of outcome values and the plurality of causal variable values.

The term “optimal causal variable value” may refer to a data construct that describes a causal variable value comprising a maximum value on a causal benefit curve associated with a resource-receiving entity cohort.

The term “resource-receiving entity cohort” may refer to a data construct that describes a group of resource-receiving entities including members that share a defining characteristic or criteria. In one embodiment, resource-receiving entity cohorts may be generated based on a clustering of resource-receiving entities from a dataset comprising historical data. For example, resource-receiving entity cohorts may be generated based on grouping of entities having similar values for one or more selected variables (causal or non-causal).

The term “optimum operation configuration” may refer to instructions or logic for varying causal variable values for a plurality of resource-receiving entity cohorts or a subset of the plurality of resource-receiving entity cohorts based on an aggregate of optimal causal variable values from the plurality of resource-receiving entity cohorts.

### IV. Overview and Technical Improvements

Various embodiments of the present disclosure make important technical contributions to improving allocation of limited resources. In particular, various embodiments of the present disclosure comprise systems and corresponding methods for determining an optimal amount of resources to allocate to resource-receiving entities in each of one or more resource-receiving entity cohorts based on non-linear causal effect predictions, and determining an optimum operation configuration based on the determined optimal amount of resource. In doing so, the techniques described herein improve performance, e.g., resource-to-benefit, outcomes of any given computing system. Accordingly, the techniques described herein improve at least one of the computational efficiency, storage-wise efficiency, and operational efficiency of computational systems.

For example, various embodiments of the present disclosure improve resource allocation by predicting non-linear causal effect of selected amounts of resources assigned to specific resource-receiving entities on an outcome of interest. As described herein, computing systems may have finite resources available to fulfill resource requests, and as such, decisions may need to be made to prioritize resource requests in order to allocate resources most effectively. To effectively distribute resources, knowledge of non-linear causal effect of any single resource allocation on an outcome of interest may be essential, and non-linear causal effect specific to a particular cohort of resource-receiving entities may be considered to capture different requirements of different cohort of resource-receiving entities.

Existing techniques may comprise assessing resource-receiving entities based on historical activity and predicted future cost computed using either deterministic rules or with an associative artificial intelligence predictive model. The assessment may be used to categorize resource-receiving entities into different risk levels, with the most-critical resource-receiving entities in a highest risk group. Each risk level may then be assigned a standard number of resources based on e.g., system default values.

However, such a technique is limited in its application in determining whether additional allocation of resources will provide added benefit to certain resource-receiving entities because they can only be used to identify resource-receiving entities that require resources, but they are incapable of estimating the impact of each resource allocation. As such, the aforementioned technique is used for prioritization of resource-receiving entities and allocation of scarce resources, under the assumption that resource-receiving entities with the greatest risk of a negative event are also the resource-receiving entities who would benefit most from additional resource allocation, but this is not always true.

However, in accordance with various embodiments of the present disclosure, a resource allocation machine learning framework may be configured to determine resource-receiving entity cohorts benefiting most from one or more resource allocations based on a non-linear causal effect prediction. In particular, the resource allocation machine learning framework may comprise a non-linear causal inference machine learning model that is trained to predict non-linear causal effects of resource allocation to resource-receiving entities for an outcome of interest based on historical data and directed acyclic graph data. As such, one or more non-linear causal effect predictions of one or more causal variables (e.g., amount of resource allocation) on an outcome of interest may be performed based on historical data and directed acyclic graph data. This technique will lead to higher success of resource allocation operations as needed for certain resource-receiving entities. In doing so, the techniques described herein improve efficiency and quality-of-service. Accordingly, the techniques described herein improve at least one of the computational efficiency, storage-wise efficiency, and operational efficiency of computational systems.

### V. Example System Operations

As indicated, various embodiments of the present disclosure make important technical contributions to improving allocation of limited resources. In particular, various embodiments of the present disclosure comprise systems and corresponding methods for determining an optimal amount of resources to allocate to resource-receiving entities in each of one or more resource-receiving entity cohorts based on non-linear causal effect predictions, and determining an optimum operation configuration based on the determined optimal amount of resource. In doing so, the techniques described herein improve performance, e.g., resource-to-benefit, outcomes of any given computing system. Accordingly, the techniques described herein improve at least one of the computational efficiency, storage-wise efficiency, and operational efficiency of computational systems.

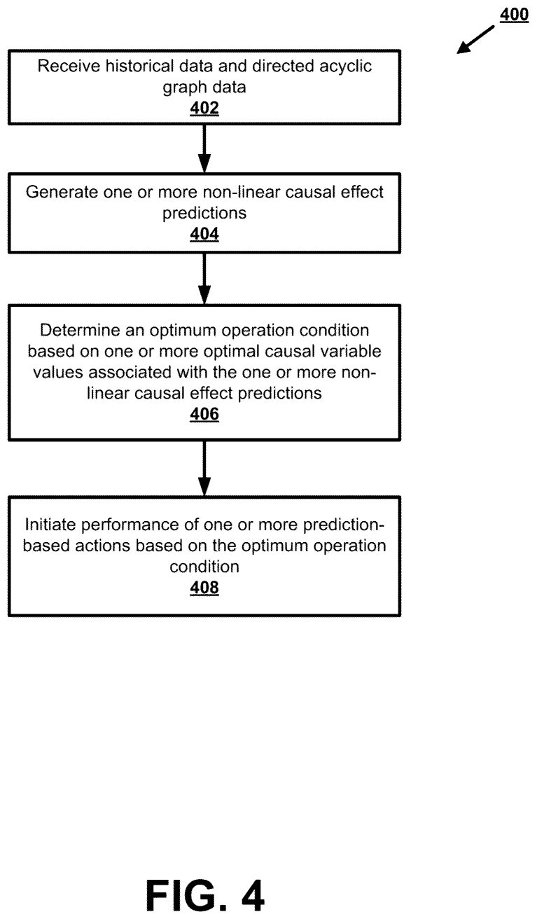

FIG. 4 is a flowchart diagram of an example process 400 for determining optimal resource allocation quantity or frequency to resource-requesting entities.

In some embodiments, a resource-requesting entity describes an object, article, file, program, service, task, operation, computing, and/or the like unit that receives resources or actions as a resource, to execute an operation, perform a task, maintain or advance a state, or continue functioning. A resource-receiving entity may be allocated resources either upon a given condition, as determined by a policy, or periodically. For example, a computing device may determine whether to allocate a resource to a resource-receiving entity.

In some embodiments, a resource describes a physical or virtual component of limited availability, such as within or may be provided by a computer system. For example, connected devices and system components may be accessed as resources. Virtual resources may include files, network connections, and memory areas. Additional examples of resources may comprise computation time, a number of steps necessary to solve a problem, processes, tasks, services, and memory space, such as an amount of storage needed while solving the problem. In some embodiments, a resource may also be associated with a stock or supply of money, materials, staff, support, and other assets that can be drawn on by a computing system.

In some embodiments, aia the various steps/operations of the process 400, the predictive data analysis computing entity 106 uses a resource allocation machine learning framework to generate non-linear causal effect predictions of one or more causal variables on an outcome of interest associated with the one or more resource-receiving entities for determining the most efficient usage and/or allocation of available resources.

In some embodiments, the process 400 begins at step/operation 402 when the predictive data analysis computing entity 106 receives historical data and directed acyclic graph data.

In some embodiments, historical data describes a recording of structured and/or unstructured data associated with actions, such as resource allocations, with respect to one or more resource-receiving entities and outcomes as a result of the actions. In one embodiment, historical data may comprise data records associated with one or more outcomes of interest for one or more resource-receiving entities. A data record may comprise one or more causal variables, respective causal variable values of the one or more causal variables, actions, one or more outcome values associated with the one or more causal variables with the respective causal variable values and the actions, and a pre-defined time window. As an example, historical data may comprise a log of activity, events, diagnosis, statistics, actions or procedures, and any other information associated with the one or more resource-receiving entities. The historical data may be stored in a database and provided as input to a resource allocation machine learning framework for generating a non-linear causal effect prediction output.

In some embodiments, directed acyclic graph data describes expert knowledge data comprising one or more relationships between different causal variables (e.g., independent variables), confounders, and outcomes (e.g., dependent variables). Directed acyclic graph data may comprise a directed acyclic graph data object that is representative of a causal diagram including assumptions, for example, variables to control for (e.g., accounting for extraneous or non-causal variables), and relationships (e.g., directed) between different causal variables, actions, and outcomes. In some embodiments, directed acyclic graph data may be stored on one or more databases and retrieved as input to a causal inference machine learning model to impart expert knowledge about relationships between different data points. As an example, directed acyclic graph data may include directionality of how variable ‘X’ causes variable ‘Y’ (and not vice versa), of how variable ‘Z’ depends on variable ‘X’ but not on variable ‘Y,’ of how variable ‘W’ causes variables ‘Z’ and ‘Y’ but not variable ‘X.’

In some embodiments, at step/operation 404, the predictive data analysis computing entity 106 generates, using a resource allocation machine learning framework, one or more non-linear causal effect predictions of one or more causal variables on an outcome of interest associated with the one or more resource-receiving entities based on the historical data and the directed acyclic graph data. In some embodiments, a non-linear causal effect prediction describes an effect of varying values of one or more causal variables on an outcome of interest based on historical data and directed acyclic graph data. For example, a non-linear causal effect prediction may identify the causal effect of increasing a causal variable value of a causal variable representative of a quantity of resource allocations for a resource-receiving entity. Each resource allocation may be assumed to be equivalent or identical, e.g., a first resource allocation is the same as an n-th resource allocation. In one embodiment, a non-linear causal effect prediction is made based on the historical data and the directed acyclic graph data.

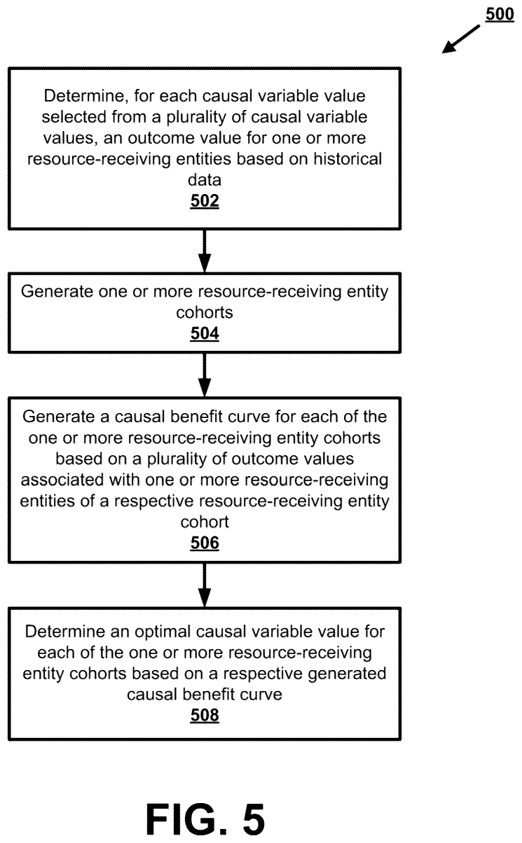

In some embodiments, a non-linear causal effect prediction may account for non-linear or diminishing return effect of increasing a value of a selected causal variable to achieve an outcome of interest for a resource-receiving entity that already has a large value for the selected causal variable, or conversely, of decreasing a value of a selected causal variable to achieve an outcome of interest for a resource-receiving entity that already has a small value for the selected causal variable. In some embodiments, generating the non-linear causal effect prediction may further comprise determining an optimal causal variable value for each of one or more resource-receiving entity cohorts by a non-linear causal inference machine learning model. Determining optimal causal variable values are described in further detail with respect to the description of FIG. 5.

In some embodiments, a causal variable describes an independent variable associated with an action that produces a causal effect that may be either linear or non-linear. In one embodiment, a causal variable may comprise an action that produces a causal effect. For example, a causal variable may comprise a data variable associated with quantity of actions (e.g., resource allocations) enacted on a resource-receiving entity. According to various embodiments of the present disclosure, a causal effect on an outcome of interest associated with a resource-receiving entity may be attributed to a causal variable. That is, a causal variable, such as quantity of actions, may effect a linear or non-linear change in an outcome of interest associated with a resource-receiving entity.

In some embodiments, a causal variable represents quantity of actions (e.g., resource allocations) and a causal variable value for the causal variable comprises a numerical value corresponding to the quantity of actions. According to another example, a causal variable may represent a data field, and a causal variable value for the causal variable may comprise a binary, decimal, or hexadecimal value representative of an existence of an attribute and/or a descriptor of the data field.

In some embodiments, an outcome of interest describes a dependent variable that is varied based on causal variable values selected for one or more causal variables. Generally, an outcome of interest may represent a desired state or condition of a resource-receiving entity. The outcome of interest may also be an outcome associated with a resource-receiving entity that is measurable, such as failure rates, number of servicing/maintenance visits, or results of testing or diagnosis.

In some embodiments, at step/operation 406, the predictive data analysis computing entity 106 determines an optimum operation configuration based on one or more optimal causal variable values associated with the one or more non-linear causal effect predictions. In some embodiments, the non-linear causal effect prediction may comprise an optimal causal variable value determined for each of one or more resource-receiving entity cohorts by a non-linear causal inference machine learning model. In some embodiments, an optimal causal variable value describes a causal variable value comprising a maximum value on a causal benefit curve associated with a resource-receiving entity cohort. In one embodiment a causal benefit curve may be generated for a resource-receiving entity cohort by applying a supervised machine learning regression to a plurality of outcome values and a plurality of causal variable values associated with resource-receiving entities of the resource-receiving entity cohort based on historical values and a directed acyclic graph. In some embodiments, an outcome value describes a quantitative value representative of a causal effect of a causal variable value selected for a causal variable on an outcome of interest associated with a resource-receiving entity.

In some embodiments, an optimum operation configuration comprises instructions or logic for varying causal variable values for a plurality of resource-receiving entity cohorts or a subset of the plurality of resource-receiving entity cohorts based on an aggregate of optimal causal variable values from the plurality of resource-receiving entity cohorts. For example, varying causal variable values according to an optimum operation configuration may comprise adjusting an action associated with a causal variable, e.g., resource allocation, to achieve an outcome of interest (with respect to the plurality of resource-receiving entity cohorts or a subset of the plurality of resource-receiving entity cohorts) while not exceeding a causal variable cost threshold.

In some embodiments, a cost is associated with varying a causal variable value. The cost may be financial, opportunity, or performance in nature. For example, a causal variable may be associated with allocation of resources to a resource-receiving entity, and for every additional increase in the value of the causal variable, a cost may increase for the resource-receiving entity to implement the increase in the value of the causal variable. As such, a causal variable cost threshold may represent a maximum cost allowable, either as an absolute value or rate over a specific period of time, associated with varying a causal variable value. Accordingly, an optimum operation configuration may be further determined based on a causal benefit of an action associated with a selected causal variable, such as resource allocation, with respect its cost (e.g., a cost-benefit analysis). This, one or more causal variables may be set or increased to predetermined values (an absolute value or frequency) based on the optimum operation configuration to account for resource-receiving entities in need while preventing exhaustion of finite resources.

In some embodiments, at step/operation 408, the predictive data analysis computing entity 106 initiates the performance of one or more prediction-based actions based on the optimum operation configuration. Initiating the performance of the one or more prediction-based actions based on the optimum operation configuration comprises, for example, performing a resource-based action (e.g., allocation of resource), generating a diagnostic report, generating action scripts, generating alerts or messages, or generating one or more electronic communications. The one or more prediction-based actions may further include displaying visual renderings of the aforementioned examples of prediction-based actions in addition to values, charts, and representations associated with the optimum operation configuration using a prediction output user interface.

FIG. 5 is a flowchart diagram of an example process 500 for determining optimal causal variable values. In some embodiments, generating the one or more non-linear causal effect predictions (e.g., step/operation 404) may further comprise determining optimal causal variable values. Via the various steps/operations of the process 500, the predictive data analysis computing entity 106 can use a non-linear causal inference machine learning model of a resource allocation machine learning framework to determine optimal causal variable values. In one embodiment, the non-linear causal inference machine learning model may comprise a non-parametric double/debiased machine learning model.

In some embodiments, at step/operation 502, the predictive data analysis computing entity 106 determines, for each causal variable value selected from a plurality of causal variable values, an outcome value for one or more resource-receiving entities based on historical data. The plurality of outcome values and the plurality of causal variable values may be determined based on historical values and a directed acyclic graph (e.g., step/operation 402). For example, a resource-receiving entity may be associated with an outcome value and a causal variable value based on the historical data.

In some embodiments, at step/operation 504, the predictive data analysis computing entity 106 generates one or more resource-receiving entity cohorts. In some embodiments, a resource-receiving entity cohort describes a group of resource-receiving entities including members that share a defining characteristic or criteria. In one embodiment, resource-receiving entity cohorts may be generated based on a clustering of resource-receiving entities from a dataset comprising historical data. For example, resource-receiving entity cohorts may be generated based on grouping of entities having similar values for one or more selected variables (causal or non-causal).

In some embodiments, at step/operation 506, the predictive data analysis computing entity 106 generates a causal benefit curve for each of the one or more resource-receiving entity cohorts based on a plurality of outcome values associated with one or more resource-receiving entities of a respective resource-receiving entity cohort. In some embodiments, the causal benefit curve may be generated by applying supervised machine learning regression to a plurality of outcome values (determined as described in a previous step/operation) associated with one or more resource-receiving entities of a respective resource-receiving entity cohort based on a directed acyclic graph.

In some embodiments, supervised machine learning regression describes analysis performed by a machine learning model, such as a non-linear causal inference machine learning model, to model a relationship between one or more independent variables (e.g., causal variables) and a dependent variable (e.g., outcome of interest). For example, supervised machine learning regression may comprise identifying or determining an effect of causal variables (e.g., allocation of resources) on an outcome of interest for members of a selected resource-receiving entity cohort over a period of time. In one embodiment, supervised machine learning regression may comprise a prediction of a continuous value that forecasts a trend by generating a causal benefit curve associated with a plurality of outcome values and a plurality of causal variable values. The generated causal benefit curve may comprise a best-fit curve between data values of a plot between the plurality of outcome values and the plurality of causal variable values.

In some embodiments, at step/operation 508, the predictive data analysis computing entity 106 determines an optimal causal variable value for each of one or more resource-receiving entity cohorts based on a respective generated causal benefit curve. As discussed above, each of the one or more resource-receiving entities may be associated with a given resource-receiving entity cohort. As such, an optimal causal variable value may be determined for a selected resource-receiving entity cohort by analyzing non-linear causal effect predictions for each resource-receiving entity belonging to the selected resource-receiving entity cohort. For example, the analysis may include determining a maximum (e.g., obtained by calculating a derivative) on a causal benefit curve for the selected resource-receiving entity cohort. In other words, the optimal causal variable value may be determined based on when an expected benefit associated with a causal variable begins to level off. In one embodiment, an optimal causal variable value curve may be generated by calculating, for example, a derivative, for one or more values along the causal benefit curve. Accordingly, optimal causal variable values may be used to determine optimum response levels for different resource-receiving cohorts.

In some embodiments, a resource allocation machine learning framework is applied to various systems and industries where resources may be limited, such as in financial resources, inventory, human skills, production resources, or information technology and natural resources. For example, a resource allocation machine learning framework may be used in a healthcare setting to identify the non-linear causal effect of a clinical touchpoint (a causal variable). A non-linear causal inference machine learning model may be developed by combining historical health data, a directed acyclic graph, and implementing non-parametric double/debiased machine learning.

In some embodiments, the historic health data is collected on members who received various frequencies of clinical touchpoints including observed outcomes of these members in months/years over a pre-defined time window. In an example embodiment, the historical health data may comprise medical claims (e.g., diagnosis, procedure, prescriptions), medical labs data (e.g., glucose, GFR, BMI), medical charts (via extraction of terms/phrases using natural language processing—e.g., “pain”, “deteriorating,” “forgetful”), and member information (e.g., age, gender, ethnicity, social determinants of health).

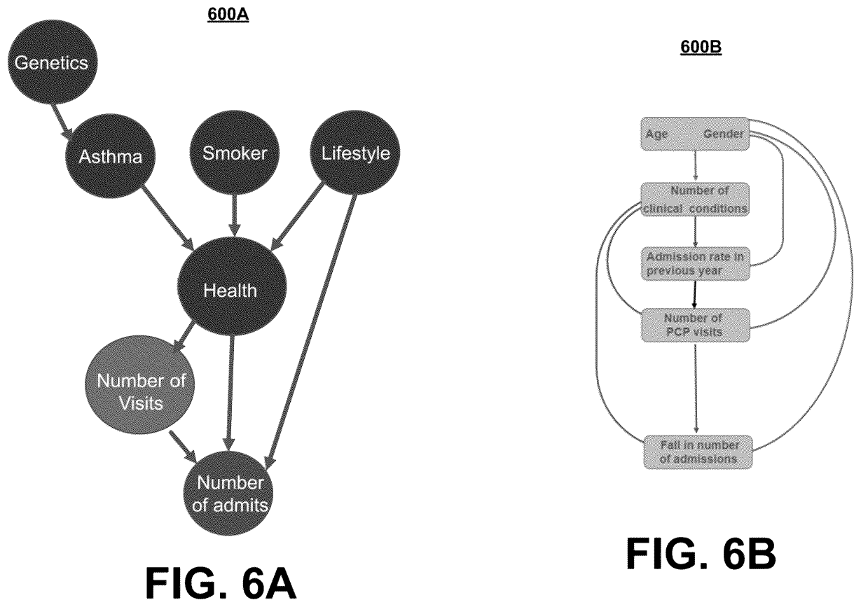

In some embodiments, a directed acyclic graph is generated by, for example, a team of data scientists and health care experts. For example, a directed acyclic graph may comprise a causal diagram which contains prior assumptions about how a clinical touch point being modeled works. Operational examples of directed acyclic graphs 600A and 600B are depicted in FIG. 6A and FIG. 6B, respectively. As depicted in FIG. 6B and FIG. 6B, in some embodiments, the disclosed resource allocation machine learning framework may be used in a healthcare setting.

In some embodiments, referring to FIG. 6A, directed acyclic graph 600A comprises a graph data object comprising expert knowledge data that defines directed relationships between confounders (genetics, asthma, being a smoker, lifestyle, and health), causal variables (number of visits), and outcome of interest (number of admits).

In some embodiments, referring to FIG. 6B, directed acyclic graph 600B comprises a graph data object comprising expert knowledge data associated with an effect of the number of primary care physician (PCP) visits on general admissions rate. The directed acyclic graph 600B defines interrelated and directed relationships among confounders (age gender, number of clinical conditions, admission rate in previous year), causal variables (number of primary care physician (PCP) visits), and an outcome (fall in number of admissions.

In some embodiments, any established method for estimating non-linear causal effects for continuous treatment variables may be selected. For example, the non-parametric double/debiased machine learning may be used. Non-parametric double/debiased machine learning may use supervised machine learning regression techniques to compute the causal effect for each value of the causal variable. For example, the causal reduction in the number of admissions (e.g., outcome of interest) may be A) ‘1’ per year when the number of touchpoints (causal variable) is 3 per year (causal variable value), and B) 2 per year when the number of touchpoints is 4 per year. It follows that for each distinct causal variable value (number of touchpoints per year), a corresponding causal effect value (fall in the number of admissions per year) is affected.

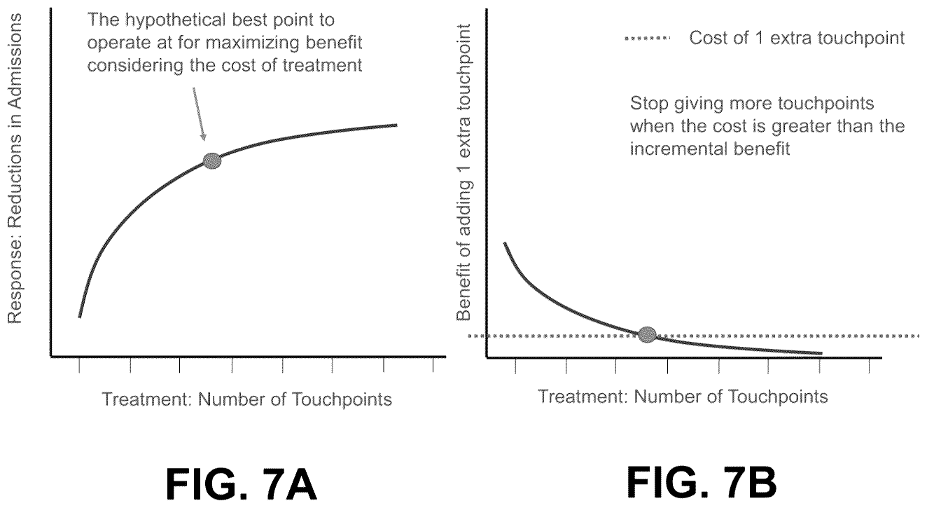

Examples of non-linear causal effect are depicted in FIG. 7A and FIG. 7B. FIG. 7A depicts the non-linear causal effect of a number of touchpoints (e.g., causal variable) on reductions in admissions (e.g., outcome of interest) via a causal benefit curve. From such a graph depicted in FIG. 7A it may then be possible to identify the best point to operate at comparing the expected benefit against the cost (financial or opportunity cost) of the extra treatment as depicted in FIG. 7B, which may comprise an optimal causal variable value.

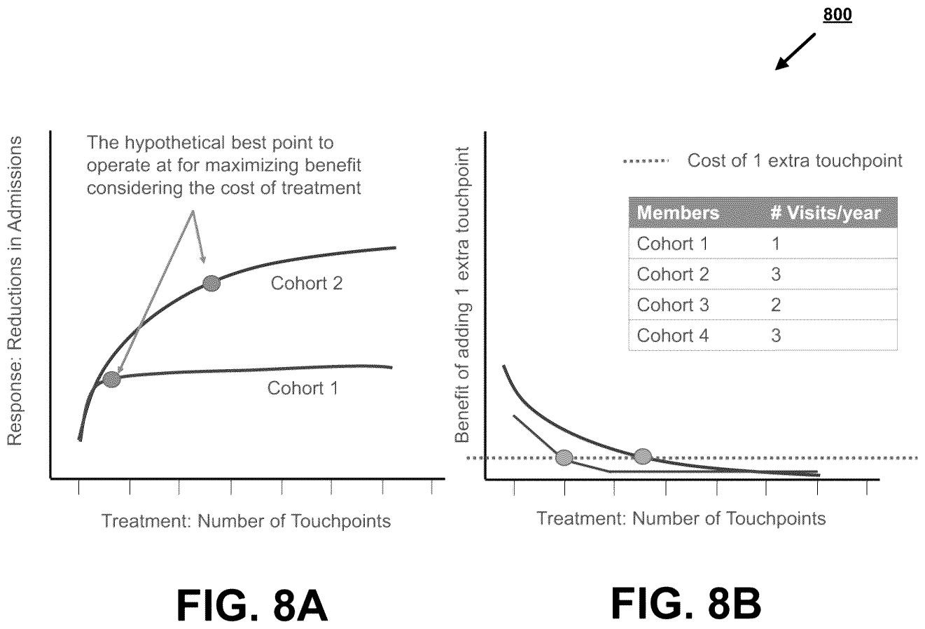

The disclosed methods may be used to determine the causal effect of an entire population of resource-receiving entities (e.g., find the expected effect of increasing the number of clinical touchpoints on the general admissions rate). Operational examples of different causal benefit curves for respective resource-receiving entity cohorts are depicted in FIG. 8A and FIG. 8B. Each curve may be associated with a different cohort of resource-receiving entities to determine the causal effect in a sub-group of a population (e.g., members who are defined to be of certain risk groups or top percentage according to a certain criteria of an overall membership). By repeating the disclose causal analysis for different cohorts (e.g., such as healthy members vs diabetic members, etc.), it is possible to identify different optimum operating configurations for each cohort.

FIG. 8B depicts an example of a non-linear (diminishing returns) causal effect where the added benefit of adding additional touchpoints plateaus (e.g., optimal causal variable value). An optimum allocation may be chosen based on when the expected benefit begins to level off.

Accordingly, as described above, various embodiments of the present disclosure make important technical contributions to improving allocation of limited resources. In particular, various embodiments of the present disclosure comprise systems and corresponding methods for determining an optimal amount of resources to allocate to resource-receiving entities in each of one or more resource-receiving entity cohorts based on non-linear causal effect predictions, and determining an optimum operation configuration based on the determined optimal amount of resource. In doing so, the techniques described herein improve performance, e.g., resource-to-benefit, outcomes of any given computing system. Accordingly, the techniques described herein improve at least one of the computational efficiency, storage-wise efficiency, and operational efficiency of computational systems.

### VI. Conclusion

Many modifications and other embodiments will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

1. A computer-implemented method comprising:
receiving, by one or more processors, historical data and directed acyclic graph data, wherein: (i) the historical data comprises one or more outcome values associated with one or more resource-receiving entities, (ii) each of the one or more outcome values associated with a causal variable value and a pre-defined time window, and (iii) the directed acyclic graph data comprises expert knowledge data;
generating, by the one or more processors and using a resource allocation machine learning framework, one or more non-linear causal effect predictions of one or more causal variables on an outcome of interest associated with the one or more resource-receiving entities based at least in part on the historical data and the directed acyclic graph data, wherein:
(a) the resource allocation machine learning framework comprises a non-linear causal inference machine learning model,
(b) the non-linear causal inference machine learning model is configured to: (i) determine, for each causal variable value selected from a plurality of causal variable values, an outcome value for one or more resource-receiving entities based at least in part on the historical data, and (ii) determine an optimal causal variable value for each of one or more resource-receiving entity cohorts by applying supervised machine learning regression to a plurality of outcome values associated with one or more resource-receiving entities of a respective resource-receiving entity cohort based at least in part on the directed acyclic graph;
determining, by the one or more processors, an optimum operation configuration based at least in part on one or more optimal causal variable values associated with the one or more non-linear causal effect predictions; and
initiating, via the one or more processors, the performance of one or more prediction-based actions based at least in part on the optimum operation configuration.

2. The computer-implemented method of claim 1, wherein the non-linear causal inference machine learning model comprises a non-parametric double/debiased machine learning model.

3. The computer-implemented method of claim 1, wherein the expert knowledge data comprises one or more relationships between selected causal variables, outcomes, and actions.

4. The computer-implemented method of claim 1, wherein the one or more causal variables comprise a data variable associated with a quantity of resource allocations enacted on a resource-receiving entity.

5. The computer-implemented method of claim 1, wherein the one or more resource-receiving entities comprise objects, articles, files, programs, services, tasks, operations, or computing units that receive resource allocations from a computing device.

6. The computer-implemented method of claim 1, wherein applying the supervised machine learning regression further comprises:
determining a plurality of outcome values and a plurality of causal variable values based at least in part on the historical values and the directed acyclic graph; and
generating a causal benefit curve based at least in part on the plurality of outcome values and the plurality of causal variable values.

7. The computer-implemented method of claim 1 further comprising:
determining the optimal causal variable value by maximizing the outcome value based at least in part on the causal benefit curve and a causal variable cost threshold associated with the causal variable.

8. A computing apparatus comprising a processor and memory including program code, the memory and the program code configured to, when executed by the processor, cause the computing apparatus to:
receive historical data and directed acyclic graph data, wherein: (i) the historical data comprises one or more outcome values associated with one or more resource-receiving entities, (ii) each of the one or more outcome values associated with a causal variable value and a pre-defined time window, and (iii) the directed acyclic graph data comprises expert knowledge data;
generate, using a resource allocation machine learning framework, one or more non-linear causal effect predictions of one or more causal variables on an outcome of interest associated with the one or more resource-receiving entities based at least in part on the historical data and the directed acyclic graph data, wherein:
(a) the resource allocation machine learning framework comprises a non-linear causal inference machine learning model,
(b) the non-linear causal inference machine learning model is configured to: (i) determine, for each causal variable value selected from a plurality of causal variable values, an outcome value for one or more resource-receiving entities based at least in part on the historical data, and (ii) determine an optimal causal variable value for each of one or more resource-receiving entity cohorts by applying supervised machine learning regression to a plurality of outcome values associated with one or more resource-receiving entities of a respective resource-receiving entity cohort based at least in part on the directed acyclic graph;
determine an optimum operation configuration based at least in part on one or more optimal causal variable values associated with the one or more non-linear causal effect predictions; and
initiate the performance of one or more prediction-based actions based at least in part on the optimum operation configuration.

9. The computing apparatus of claim 8, wherein the non-linear causal inference machine learning model comprises a non-parametric double/debiased machine learning model.

10. The computing apparatus of claim 8, wherein the expert knowledge data comprises one or more relationships between selected causal variables, outcomes, and actions.

11. The computing apparatus of claim 8, wherein the one or more causal variables comprise a data variable associated with a quantity of resource allocations enacted on a resource-receiving entity.

12. The computing apparatus of claim 8, wherein the one or more resource-receiving entities comprise objects, articles, files, programs, services, tasks, operations, or computing units that receive resource allocations from a computing device.

13. The computing apparatus of claim 8, wherein applying the supervised machine learning regression further comprises:
determining the plurality of outcome values and a plurality of causal variable values based at least in part on the historical values and the directed acyclic graph; and
generating a causal benefit curve based at least in part on the plurality of outcome values and the plurality of causal variable values.

14. The computing apparatus of claim 8, wherein the computing apparatus is further caused to:
determine the optimal causal variable value by maximizing the outcome value based at least in part on the causal benefit curve and a causal variable cost threshold associated with the causal variable.

15. A computer program product comprising a non-transitory computer-readable storage medium, the non-transitory computer-readable storage medium including instructions that, when executed by a computing apparatus, cause the computing apparatus to:
receive historical data and directed acyclic graph data, wherein: (i) the historical data comprises one or more outcome values associated with one or more resource-receiving entities, (ii) each of the one or more outcome values associated with a causal variable value and a pre-defined time window, and (iii) the directed acyclic graph data comprises expert knowledge data;
generate, using a resource allocation machine learning framework, one or more non-linear causal effect predictions of one or more causal variables on an outcome of interest associated with the one or more resource-receiving entities based at least in part on the historical data and the directed acyclic graph data, wherein:
(a) the resource allocation machine learning framework comprises a non-linear causal inference machine learning model,
(b) the non-linear causal inference machine learning model is configured to: (i) determine, for each causal variable value selected from a plurality of causal variable values, an outcome value for one or more resource-receiving entities based at least in part on the historical data, and (ii) determine an optimal causal variable value for each of one or more resource-receiving entity cohorts by applying supervised machine learning regression to a plurality of outcome values associated with one or more resource-receiving entities of a respective resource-receiving entity cohort based at least in part on the directed acyclic graph;
determine an optimum operation configuration based at least in part on one or more optimal causal variable values associated with the one or more non-linear causal effect predictions; and
initiate the performance of one or more prediction-based actions based at least in part on the optimum operation configuration.

16. The computer program product of claim 15, wherein the non-linear causal inference machine learning model comprises a non-parametric double/debiased machine learning model.

17. The computer program product of claim 15, wherein the expert knowledge data comprises one or more relationships between selected causal variables, outcomes, and actions.

18. The computer program product of claim 15, wherein the one or more causal variables comprise a data variable associated with a quantity of resource allocations enacted on a resource-receiving entity.

19. The computer program product of claim 15, wherein applying the supervised machine learning regression further comprises:
determining the plurality of outcome values and a plurality of causal variable values based at least in part on the historical values and the directed acyclic graph; and
generating a causal benefit curve based at least in part on the plurality of outcome values and the plurality of causal variable values.

20. The computer program product of claim 15 further comprising instructions that, when executed by the computing apparatus, cause the computing apparatus to:
determine the optimal causal variable value by maximizing the outcome value based at least in part on the causal benefit curve and a causal variable cost threshold associated with the causal variable.
